(19) United States
(12) Patent Application Publication
(10) Pub. No.: US 2025/0128165 A1
(43) Pub. Date: Apr. 24, 2025

(54) USER INTERFACE FOR PROVIDING EDITING OF STORYLINE USING THUMBNAILS SHOWING OBJECTS, EACH OF WHICH CAN BE DISPLAYED WITH THEIR VARIATIONS TO ALLOW FOR ON-THE-FLY GENERATION OF OBJECTS

(71) Applicant: Sony Interactive Entertainment LLC, San Mateo, CA (US)

(72) Inventors: Mahdi Azmandian, San Mateo, CA (US); Tatianna Forget, San Mateo, CA (US)

(21) Appl. No.: 18/489,815

(22) Filed: Oct. 18, 2023

(51) Int. Cl. A63F 13/63; A63F 13/47; G06T 11/60; G06V 10/22

(52) U.S. Cl. CPC A63F 13/63; A63F 13/47; G06T 11/60; G06V 10/235

(57) ABSTRACT

Methods and systems for generating a storyline usable to develop an interactive application includes receiving inputs from a user for developing the storyline. A first portion of the storyline is generated using prompts included in the inputs. The storyline generated includes a first set of thumbnails and text content describing content included in each thumbnail in the first set. Selection of a portion of the storyline for editing is detected and, in response, a plurality of additional prompts is generated and presented on a user interface. User selection of an additional prompt is used to edit a current version of the specific portion of the storyline to generate modified storyline. The modified storyline used to develop the interactive application.

### BACKGROUND OF THE INVENTION

### 1. Field of the Invention

The present disclosure relates to receiving user inputs to generate a storyline and more specifically using user inputs selecting an image or a portion of text content generated for the storyline to adjust the storyline.

### 2. Description of the Related Art

User interaction with online content has become mainstream with a variety of content being presented or generated for user consumption. Of particular interest is the growing popularity of video games. A user selects a video game for playing and provides game inputs to affect a game state of the video game and to update game data. The updated game data is used to generate game scenes that are returned to the client device for rendering. The storyline is already determined by a game developer for the video game and, depending on the user's preference to the storyline, the user selects the video game for interaction. The user is not able to develop their own storyline for a video game or change the storyline of the video game that has already been developed.

In addition to being unable to develop their own storyline, the users are also unable to customize the game assets that can be used in the video game. Allowing the user to customize a video game as well as game assets usable in the video game will allow the user to become more interested and engaged in playing the video game.

It is in this context that embodiments of the invention arise.

### SUMMARY OF THE INVENTION

Implementations of the present disclosure relate to systems and methods for providing a developer tool to a user to allow the user to provide prompts that can be used to define a storyline usable for defining a customized interactive application, such as a video game. Although various implementations will be discussed with reference to developing a storyline for a video game, the implementations can be extended to developing a storyline for a book or for other interactive applications, as well. Typically, a video game is developed for game play by following a storyline that is defined by a game developer. The storyline can be used to define the various scenes, various levels, various challenges, game assets and characters for use in defining the scenes, representing the user during gameplay, and assisting the user to overcome the challenges, in the video game. Additionally, the storyline can include specific rules that need to be followed during game play to overcome each challenge, achieve a level, or successfully complete the video game, etc., and the video game is defined in accordance to the rules.

The developer tool described in the various implementations herein provides the capability to allow the user to develop their own storyline for a defining a customized video game. To assist the user in developing their own storyline for a video game, the developer tool provides an interactive user interface for providing initial prompts for the storyline. The initial prompts may be provided as text inputs and, in some instance, can include images, as well. The images can be used to define characters and/or game scenes, for example. The prompts are interpreted by a generative artificial intelligence (GAI) engine engaged by the developer tool to define the storyline that the user envisions for the video game. In some cases, the initial prompts are used to define a first portion of the storyline and the user interface is used to receive additional prompts from the user to define subsequent portions of the storyline. The additional prompts can also be used to edit one or more portions of the initial storyline developed using the initial prompts provided by the user. The initial prompts can be interpreted to determine a number and type of characters to be used in the storyline, subject of the storyline, levels of challenges, game scenes and challenges to traverse/overcome in each game scene, type of interactions expected from each character present in the scenes or to overcome the challenges, etc. The storyline is developed to include visual representation of the storyline as well as the text defining the storyline. The visual representation can be in the form of a sequential thumbnails that include images representing the game scenes and/or characters (i.e., both non-player characters (NPC) and/or assets of the game). Specifically, the prompts are interpreted by the GAI to determine the type of story to define (e.g., adventure, role-playing, sports, simulation, fighting, action, etc.) for a video game, the rules of the game to be played, the characters and scenes to include, the challenges to present, the inputs to be provided video game, etc. by different characters to advance in the video game.

When the user wishes to edit a portion of the storyline, the GAI determines the type of change the user wishes to make to the storyline, and identify and provide appropriate additional prompts at the user interface for user selection. User selection of a specific additional prompt is used by the GAI to perform the edits to the portion. The storyline thus developed includes the user specific customization. Once the storyline is finalized by the user, the storyline is forwarded to a game engine, for example, to develop the video game, in the case where the storyline is being used to define a video game. In the case where the storyline is used to develop a storybook, for example, the finalized storyline is used to develop the storybook. The video game thus developed will include the details of the interactive application (e.g., video game, interactive storybook, etc.), such as subject matter, sequence of scenes, game challenges to include if the interactive application is a video game, characters (both game assets and game characters) to use, and rules to follow to progress in the interactive application. The developer tool makes it easy for the user to develop their own storyline for a video game by providing the necessary tools to allow the user to provide initial prompts for developing an initial storyline, and to provide additional prompts to edit the developed storyline and/or to define subsequent portion of the storyline.

In one implementation, a method for generating a storyline is disclosed. The method includes receiving inputs from a user for developing the storyline. The inputs include prompts that are usable in defining the storyline. A first portion of the storyline is generated using the prompts. The first portion includes a first set of thumbnails providing a visual representation of the storyline and text providing a description of content included in each of the first set of thumbnails. The first set of thumbnails and the text presented on a user interface for user interaction. Selection of a specific portion of the storyline for editing is detected from the user. The detection causes automatic generation of a plurality of additional prompts for editing one or more attributes of the specific portion. The plurality of additional prompts is presented on the user interface for user selection. User selection of an additional prompt rendered at the user interface is received from the user and is used to edit a current version of the specific portion of the storyline. The editing results in refining the storyline to generate a modified storyline that conforms with changes defined in the additional prompt. The modified storyline is used in developing an interactive application.

In another implementation, a method for generating a storyline is disclosed. The method includes receiving inputs from a user for developing the storyline. The inputs include prompts usable in defining the storyline. A first portion of the storyline is generated using the prompts. The first portion of the storyline includes content presented in a first set of thumbnails providing visual representation of the storyline and text describing the content included each of the first set of thumbnails. The first set of thumbnails and the corresponding text presented on a user interface for user interaction. A plurality of additional prompts is presented on the user interface for user selection. Each additional prompt of the plurality of additional prompts provides a variation to the storyline by following a distinct path. Selection of an additional prompt from the plurality of additional prompts is detected. The additional prompt defining the distinct path selected by the user is used in developing a second portion of the storyline following the first portion. The second portion of the storyline includes a second set of thumbnails providing the visual representation of the distinct path followed in the storyline and text describing the corresponding content included in each of the second set of thumbnails. The plurality of additional prompts presented and selection of the additional prompt detected continues so long as the user continues to provide inputs to develop subsequent portions of the storyline. The developed storyline is used to develop an interactive application.

Other aspects of the present disclosure will become apparent from the following detailed description, taken in conjunction with the accompanying drawings, illustrating by way of example the principles of embodiments described in the present disclosure.

### BRIEF DESCRIPTION OF THE DRAWINGS

The disclosure may be better understood by reference to the following description taken in conjunction with the accompanying drawings.

FIG. 1 represents an overview of a simplified block diagram of a system that includes a storyline developer tool for receiving user inputs and using the inputs to develop a storyline, wherein the developed storyline is used to define an interactive application, in accordance with one implementation.

FIG. 1A identifies sub-modules of a generative artificial intelligence engine used to define the storyline, in accordance with one implementation.

FIG. 2 represents a simplified view of a developer tool interface used to present the storyline developed from prompts defined by the user inputs and receive and process the inputs provided by the user in refining and/or developing additional portions of the storyline, in accordance with one implementation.

FIG. 3A illustrates a view of a developer tool interface for receiving and processing image edits provided by the user in refining a storyline developed for an interactive application, such as a video game, in accordance with one implementation.

FIG. 3B illustrates a view of a developer tool interface for receiving and processing text edits provided by the user in refining the storyline developed for the video game, for example, in accordance with an alternate implementation.

FIG. 3C illustrates a view of a developer tool interface for receiving and processing text edits to generate flashback storyline and use the text edits to ensure consistency in the storyline, in accordance with an alternate implementation.

FIG. 4 illustrates components of an example system that can be used to process requests from a user, provide content and assistance to the user to perform aspects of the various implementations of the present disclosure.

### DETAILED DESCRIPTION

Broadly speaking, implementations of the present disclosure include systems and methods for receiving user inputs from a user and use the inputs to develop a storyline for an interactive application, such as a video game. A developer tool is used to provide a developer tool interface that is used to receive user inputs for the storyline and to interpret the user inputs to define initial prompts for the storyline. The initial prompts are interpreted by the developer tool using a generative artificial intelligence (GAI) engine to define an initial storyline. The initial storyline is generated to cover a portion of the storyline, in some implementations. Alternately, the initial storyline can cover the complete storyline. The storyline generated for the initial prompts includes a sequence of thumbnails that provide visual representation of content representing the storyline and text that corresponds to the content included in each thumbnail in the sequence. The initial prompts are used by the GAI engine to define a distinct path for the storyline. The sequence of thumbnails and the accompanying text are presented on the user interface for user interaction.

The user can accept the storyline suggested by the GAI engine or may want to change a certain portion of the storyline. If the storyline generated by the GAI engine for the initial prompts provided by the user is a complete storyline and the user has accepted the storyline (i.e., has no more edits), then the storyline is forwarded to an interactive application development engine, such as a game engine used for developing a video game, to develop the game logic for the video game. If, however, the user accepts the storyline and the storyline generated for the initial prompts is for a first portion, additional prompts are provided on the user interface for user selection, wherein each additional prompt is defined to follow a distinctly different path when defining a subsequent portion of the storyline. The user selection of additional prompts is recognized and interpreted to define the subsequent portion of the storyline, wherein the subsequent portion is developed to follow the distinctly different path defined in the additional prompt. The process of providing additional inputs and interpreting the specific one of the additional prompts continues as long as the user provides the inputs to define the storyline.

The user can select to change the storyline by selecting a particular thumbnail and a portion of the particular thumbnail to change the content contained within. Alternatively, the user can select a particular portion of the text accompanying the storyline. When the user selects to change a portion of content included in a particular thumbnail, selection of the particular thumbnail provided on the user interface is detected by the GAI engine. In response to the user selection of the portion of the particular thumbnail, additional prompts are identified and provided on the user interface for user selection. The user selection of the additional prompt is used to apply the change to the content and to re-generate the storyline with the applied change to the thumbnail as well as to the corresponding text content. Similarly, user selection of a portion of the text describing the content of the particular thumbnail is detected and, in response, additional prompts defining distinctly different paths to the storyline are identified and presented for user selection. User selection of an additional prompt is used to update the corresponding text portion, and also the content included in the thumbnail. The updates to the text portion and the content of the thumbnail result in the re-generation of the storyline. In some implementations, the updates to the storyline may be propagated forward and backward to ensure consistency in the storyline. The regenerated storyline defines a modified storyline. The modified storyline is used for developing an interactive application, such as a video game or a book.

The developer tool allows the users to become a story teller or an explorer/adventurer by allowing them to develop their own interesting storylines. The developer tool provides certain level of flexibility by allowing the users to iteratively develop portions of the storyline at a time before proceeding to develop subsequent portions. In some cases, once the user is satisfied with the current portion of the storyline, the developer tool can lock in the constraints (e.g., rules need to traverse the portion) defined up to the current portion so as to avoid generating and re-generating the same portion of the storyline.

With the general understanding of the disclosure, specific implementations of using the develop tool interface to provide prompts to define a storyline for the user will now be described in greater detail with reference to the various figures. It should be noted that various implementations of the present disclosure can be practiced without some or all of the specific details. In other instances, well known process operations have not been described in detail in order not to unnecessarily obscure various embodiments of the present disclosure.

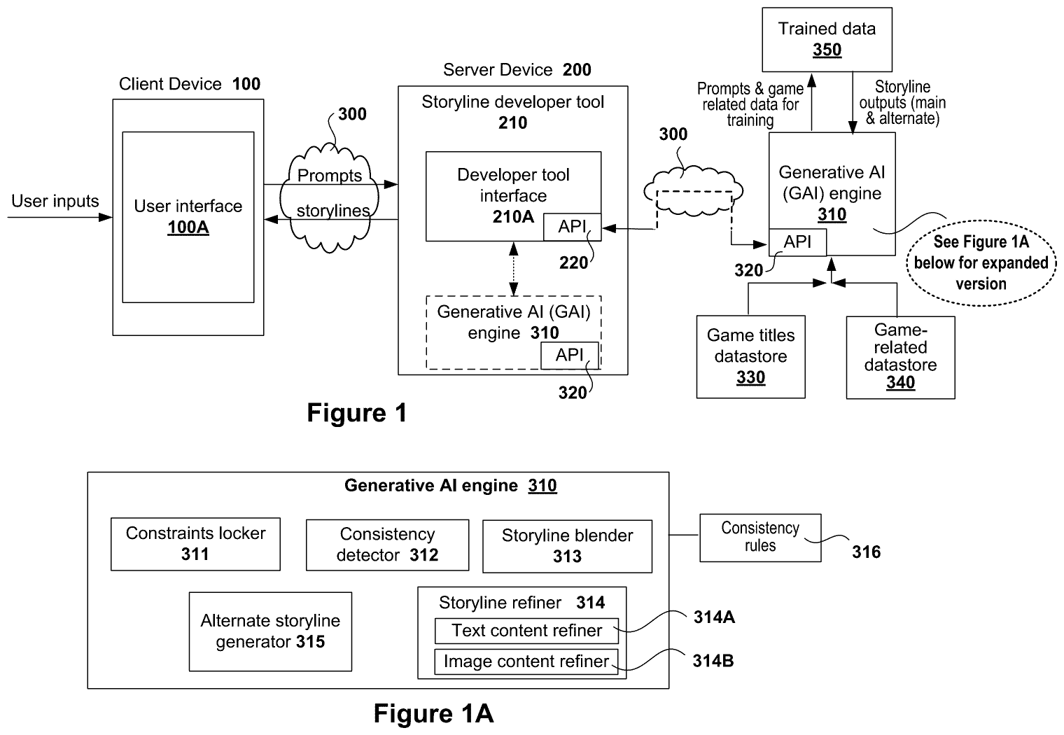

FIG. 1 represents a simplified block diagram of a system used for receiving and processing user inputs provided by the user to develop a storyline that can be used to define an interactive application, such as a video game or a children's book (e.g., comic book), etc., in accordance with some implementations. A client device 100 of a user is used to access a storyline developer tool 210 executing on a server computing device (or simply referred to as server device or server) 200 over a network 300, such as the Internet. In response to accessing the storyline developer tool 210, a developer tool interface 210A is presented on a user interface 100A defined at the client device 100. User inputs provided at the user interface 100A on the client device 100 are transmitted as prompts over the network 300 and via the developer tool interface 210A to the storyline developer tool 210 for processing. The user inputs could include text inputs, image inputs, voice inputs, or other type of inputs that can be interpreted to understand the intentions and preferences of the user for the storyline. In some implementations, the voice inputs are received via a voice user interface activated in response to the user accessing an interactive interface provided on the user interface 100A and used as voice prompts for developing the storyline. A generative artificial intelligence (GAI) engine 310 accessible to the storyline developer tool 210 is used for interpreting the prompts and generating the storyline. In some implementations, the GAI engine 310 is a proprietary engine that is trained using various prompts provided by different users, game-related data of different games, interactive application related data of different interactive applications, and various storylines generated for the different prompts. In some implementations, the GAI engine 310 is executing on the same server device 200 that is also executing the storyline developer tool 210 (shown by the broken line around GAI engine 310 in FIG. 1) and is accessed through respective application programming interfaces. In alternate implementations, the GAI engine 310 is executing on a second server that is different and external to the server device 200 executing the storyline developer tool 210. In such implementations, the GAI engine 310 is accessed over the network 300. The communication between the developer tool interface 210A and the GAI engine 310 is established through an API 220 in the developer tool interface 210A and a corresponding API 320 in the GAI engine 310.

The GAI engine 310 receives the inputs from the user, interprets the prompts included in the inputs, determines if the prompts are storyline prompts for generating a new storyline or new portion of an existing storyline, or edit prompts for editing one or more portions of the existing storyline. Based on the determination, the GAI engine 310 generates a new storyline or a new portion for the existing storyline, or updates one or more portions of the existing storying. The new or updated portion of the storyline is determined using trained data stored in the trained datastore 350, which is trained using the prompts from different users including interactions with the different interactive applications (e.g., video games, social media apps, etc.), details from the interactive applications/game titles stored in the game titles datastore 330, and the assets and game-related data stored in the game-related datastore 340. The edits are performed to one or more portions of the existing storyline by the GAI engine 310 by ensuring that any updates to the storyline resulting from the edits do not introduce any inconsistencies in the flow of the storyline. While performing the edits, when an inconsistency is detected, the GAI engine 310 is configured to identify a specific portion of the storyline where the inconsistency will occur due to edits or a specific concept of the edit prompt that is causing the inconsistency.

In some implementations, the edits to a particular portion of the storyline can cause inconsistencies in one or more portions that appear earlier to the particular portion of the storyline. Based on the type of inconsistency introduced by the edit prompts, the GAI engine 310 can identify and present additional prompts at the user interface 100A for user selection, in some implementations, to correct the inconsistency. User selection of an additional prompt is used by the GAI engine 310 to adjust the one or more of the earlier portions of the storyline so as to make the storyline flow without any inconsistencies. The additional prompts may be to provide alternate storyline or alternate narration or additional updates for applying to the one or more of the earlier portions so as to fix the inconsistency. In other implementations, the GAI engine 310 can dynamically develop an additional portion of the storyline that can be added or linked to the particular portion of the storyline so as to fix the inconsistency introduced by the edit prompt selected by the user. The content included in the additional portion is linked to a specific section of the content included in the particular portion that was edited so that the additional portion can bridge the gap in the storyline and act as a “flashback” portion of the storyline.

The storyline is generated and refined using the input prompts from the user. The resulting storyline with the concept and narrative defined and controlled by the user is used to define a video game or a storybook for a user.

FIG. 1A illustrates an overview of some of the sub-modules of the GAI engine 310 that can be used to perform different functions during generation of a storyline for a video game, in some implementations, such that the narrative of the storyline flows properly without any inconsistencies. Broadly speaking, the GAI engine 310 includes constraints locker sub-module 311, a consistency detector sub-module 312, a storyline blender sub-module 313, a storyline refiner sub-module 314, and an alternate storyline generator sub-module 315, to name a few. It is to be noted that the term “engine” as used in the GAI engine 310 or the term “sub-module” representing the various components of the GAI engine 310, in one implementation, refers to a program or piece of code that is configured to perform a certain function. The program or code may use deep learning algorithm to query certain ones of the data and/or process the data (e.g., inputs from the users, content of the video game, context of the video game, content of an interactive application, etc.). The various sub-modules included in the GAI engine 310 may assist in identifying the intentions of the user providing the user inputs to define and/or edit the storyline developed for an interactive application, such as a video game, which can then be used by machine learning algorithm to determine the type of input, the intent of the input (e.g., develop a storyline or develop additional portion of the storyline, edit select portion of the storyline, etc.), the information included in the input (e.g., select prompts for developing the storyline or portions of the storyline, alternate prompts to vary the storyline, edit portion of content of the storyline, etc.), etc., so that the necessary operations can be performed to develop or define the storyline. The GAI engine 310 can be implemented as a software, a hardware, or a firmware.

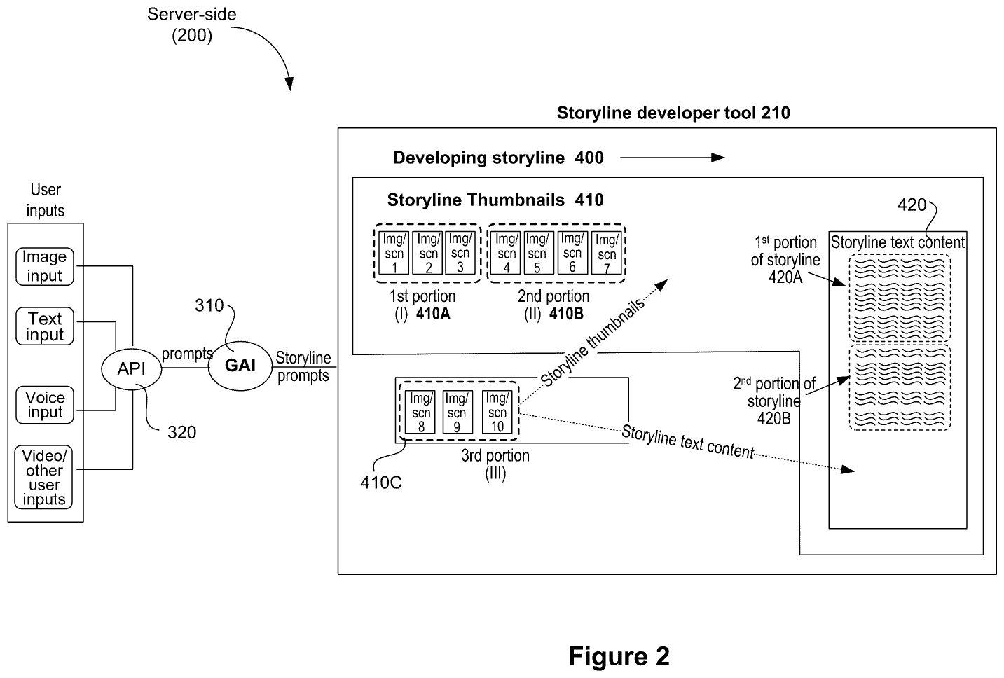

FIG. 2 illustrates details of how the storyline is generated by the storyline developer tool 210, in some implementations. The storyline is developed to include visual representations of content in the form of sequential thumbnails 410 and text content 420 describing content included in each thumbnail 410. Each thumbnail includes images to define the storyline, wherein the images can include type of storyline being developed, subject matter, characters, scenes, paths followed, challenges (if describing a storyline for a video game), etc.

Referring simultaneously to FIGS. 1A and 2, the GAI engine 310 receives the request and inputs provided by the user to develop a new storyline or edit an existing storyline developed for the user. The GAI engine 310 uses the trained data from trained datastore 350 to interpret the prompts and identify an appropriate output that define the storyline for the prompts. The output includes new data with characteristics that are similar to the existing data, wherein the new data can be a new storyline or can be variations to a portion of an existing storyline. The GAI engine 310 uses a generative AI model to identify the output. The generative AI model is generated and trained using the pattern and structure of the vast amount of data available on the Internet. The generative AI model is constantly evolving to accommodate (i.e., consider) new data as and when they are being generated and made available on the Internet. The output of the generative AI model identified by the GAI engine 310 takes into consideration the inputs provided by the user. The new data (i.e., output) can include text, images, videos, audios, storyline prompts, and other content.

The user inputs can be broadly classified into storyline prompts and edit prompts. The storyline prompts are provided when the user wants to develop a new storyline for a video game application, for example. As previously noted, the various implementations are described with reference to developing storyline for a video game but can be easily extended to other interactive applications, such as a customized storybook, etc. The edit prompts are provided when the user wishes to change a portion of the storyline that has already been developed for the video game. When the inputs (i.e., prompts) are for generating a storyline (i.e., storyline prompts) for a new video game, the inputs are interpreted by the GAI engine 310 to identify the type of video game the user wishes to develop (e.g., adventure, action, first-person shooter, sports, role-playing game, etc.) and to determine the subject matter and other details provided in the storyline prompts for developing the storyline for the video game. The GAI engine 310 uses the generative AI model to define the storyline using the details interpreted from the storyline prompts, wherein the storyline includes a sequence of storyline thumbnails (simply referred to henceforth as ‘thumbnails’) 410 providing visual representation of the storyline and storyline text content (simply referred to henceforth as ‘text’ or ‘text content’) 420 defining the content included in each of the thumbnails 410. Each of the thumbnails 410 is developed to include content, such as images of assets and characters, game scenes, game levels, etc., that correspond with the details included in the storyline. The content included in the thumbnails 410 can be used when developing the video game.

In some implementations, the storyline prompts provided by the user may include sufficient details to generate the entire storyline. In such implementations, the GAI engine 310 provides a plurality of edit options for editing any portion of the storyline. The edit options are provided at the client device 100 for rendering alongside the content (thumbnails and corresponding text describing the content of the thumbnails) of the storyline 400. The edit options provided at the client device allow the user to select either a thumbnail 410 or a portion of text 420 to edit and based on the user selection, appropriate additional prompts are identified by the GAI engine 310 and presented at the client device 100 for user selection. For example, the user can select (i.e., click) content from a portion of a particular thumbnail 410 to edit and the additional prompts provided for user selection correspond with the content selected for change. The content that user wants to edit within the portion of the thumbnail 410 can correspond to an image, wherein the image can be of a character or an asset or a scene within the thumbnail. The edits the user may wish to perform on a portion of the content can correspond to changing a type or style or way in which the image within the portion of the thumbnail 410 is to be presented in the scene. For example, the user may wish to emphasize or de-emphasize certain portion of an image, or add, remove, or adjust certain portion of the image, or reduce or lengthen an amount of time a particular content is to be rendered, or adjust the look or behavior of a specific character within the scene, etc. In the above example, the additional prompts may be provided to correspond with the type of edit the user wants to make and the type of content selected for editing. When the user selects a specific one of the additional prompts, the changes specified in the selected additional prompt are applied to content within the specific portion. The application of the changes results in the re-generation of the specific thumbnail 410.

The re-generation of the specific thumbnail 410 can also result in the re-generation of the storyline by propagating the changes to the content in forward direction to other thumbnails that follow the specific thumbnail and, in some cases, depending on the type of change performed on the specific thumbnail 410, in the reverse direction (i.e., backward direction) to content in other thumbnails that appear sequentially prior to the specific thumbnail 410 so as to keep the storyline consistent. The propagation in the backward direction may be due to the introduction of inconsistencies in one or more prior portions of the storyline 400 due to application of the changes in the specific thumbnail 410. For example, the changes to the content in the specific thumbnail may correspond to an attribute of an image of a game character that changes an appearance of the game character associated with the user (e.g., adding nerdy-looking eyeglasses to the game character). In this example, the GAI engine 310 recognizes the changes in the specific thumbnail 410 and the inconsistencies that is introduced by the changes in the looks of the game character (i.e., the game character appearing without any eyeglasses) in one or more thumbnails that appear chronologically earlier to the specific thumbnail of the storyline where the game character with the attribute appears. The consistency detector sub-module 312 is configured to detect the inconsistencies in the storyline and identify specific ones of the prior thumbnails 410 where the inconsistencies need to be addressed. In the above example, the specific thumbnail 410 that was edited to add the nerdy-looking eyeglasses to the game character could be in thumbnail 6 out of the 10 thumbnails that was generated for the storyline. However, thumbnails 2, 3 and 5 generated for the storyline could also include the game character in the content but without the nerdy-looking eyeglasses resulting in inconsistency in the looks of the game character. The consistency detector sub-module 312 is configured to analyze the content in each of the thumbnail generated for the storyline and identify specific ones of the thumbnails that includes the game character. Additionally, the analysis is used to determine which ones of the identified thumbnails includes the game character without the nerdy-looking eyeglasses. The information identified by the consistency detector sub-module 312 is provided to the storyline refiner sub-module 314. The storyline refiner sub-module 314 uses the identified thumbnails to proactively adjust the looks of the game character included within to show them wearing the nerdy-looking eyeglasses. An image content refiner 314B is used to refine the image of the game character in the identified prior thumbnails and a text content refiner 314A is used to adjust the text content corresponding to the identified prior thumbnails to narrate the game character wearing the nerdy-looking eyeglasses. The adjustment to the content in the one or more earlier portions of the storyline is used to re-generate the specific portions of the storyline and, in some cases, the entire storyline. In some alternate implementations, depending on the type of change desired by the user, the storyline refiner 314 may request and receive explicit user instructions to change content of the one or more prior thumbnails and the corresponding text content, instead of automatically adjusting the content.

In addition to providing the user with the option to select a portion of the content included in a specific thumbnail 410 (i.e., portion of a visual representation of the content) to change, the GAI engine 310 also provides the user with the option to select a portion of text content that corresponds with a particular portion of the specific thumbnail 410 for change. In some implementation, the selection of the portion of the text content is detected using an alternate storyline generator sub-module 315 to understand the context of the portion, the context of the storyline leading up to the portion of the text content, type and amount of change that the user desires to make to the text content, etc. Based on the determined context, the alternate storyline generator sub-module 315 uses information included in the trained data from the trained datastore 350 to identify and provide one or more variations to the storyline for that portion, wherein each variation defines a distinct path the storyline can follow. Each variation in the storyline is identified to match the context of the selected portion and is provided as an alternate storyline prompt for the selected portion, which is returned to the client device for rendering on the user interface 100A for user selection. User selection of a particular alternate storyline prompt is used to update the text content 420 for the selected portion of the storyline. In addition to updating the text content 420, the alternate storyline generator sub-module 315 with the help of the GAI engine 310 updates the thumbnail 410 corresponding to the portion of the selected text content so that the visual representation of the content matches the description in the updated text content 420. In some implementation, the updates to the text content and the thumbnails 410 made for the portion of the storyline is propagated forward to the text content and the thumbnails in subsequent portions of the storyline following the updated portions. The updates to the text content and the thumbnails result in the re-generation of the thumbnail and of the storyline.

In some implementations, the updates to the text content and the thumbnails are verified against the consistency rules 316 and finalized to ensure that the updates are in accordance to the consistency rules 316 defined for the video game (e.g., the type of updates, the portion of the content that can be updated, amount of change that can be applied to the portion, etc.). A constraints locker sub-module 311 is used to perform the consistency verification so that any changes to the content of the storyline does not deviate from the consistency rules 316 defined for the video game.

As noted previously, updates to the content of the storyline can introduce some inconsistencies, wherein the inconsistencies can be due to mismatch in the facts disclosed in the storyline. The mismatch can be due to applying changes from the user's edits to a portion of the storyline, for example. Some of the inconsistencies can be resolved by propagating the changes from the user's edits to the portion of the storyline to other portions in the forward and/or backward directions while some other consistencies have to be resolved by providing clarification to the storyline. For example, a change introducing a new character to assist an existing game character in a particular thumbnail 410 can cause inconsistency in the storyline as the new character was never mentioned or introduced previously in the storyline. In this example, propagating of the new character in backward direction to earlier portions of the storyline may cause more issues and conflicts in the storyline narrative than resolve the inconsistency. Thus, in order to resolve the inconsistency and avoid any conflicts in the storyline, the GAI engine 310 can engage a storyline blender sub-module 313 to detect the mismatch resulting from the introduction of the new character, review the storyline narrative up to the point of the particular thumbnail 410 to determine which prior portion of the content of the storyline can be appropriately used to introduce the new character into the storyline so that the using the assistance of the new character by the game character in the particular thumbnail 410 makes more sense. The storyline blender sub-module 313 identifies a particular prior portion of content of the storyline that provides contextual relevance to the subject matter (i.e., introduction of the new character) that is causing the inconsistency, and uses the content and the context of the particular prior portion to develop an additional portion of the storyline that corresponds to the introduction of the new character into the storyline. For example, the storyline for an adventure video game may have been developed from the user prompts and include a set of 15 thumbnails and text content that describe the content included in the 15 thumbnails.

The storyline can include a game character that has solely embarked on the adventure and is shown to be interacting with different game assets and other game characters defined in different game scenes included in the set of thumbnails, wherein the thumbnails provide the visual representation of the content of the storyline and activities occurring in the storyline, and can include images, videos, audios, etc., pertaining to the characters, assets, scenes, etc. In this example, the content of the storyline represented in thumbnail 8 may show the game character being trapped in a bear trap and the changes may have been to have the game character call out to his friend (i.e., new character) to assist him in getting out of the bear trap. However, the storyline presented in thumbnails 1-8 never mentioned the presence of the game character's friend. The storyline blender sub-module 313 is configured to detect the inconsistency in the storyline due to the sudden inclusion of the friend (i.e., new character) for assisting the game character in the storyline narration of a portion of content included in the thumbnail 8 and analyze the portion of the storyline narrated up to the portion of content in the thumbnail 8 where the new character is introduced to determine an appropriate portion of the earlier storyline to use to make the storyline flow consistently. Based on the analysis, the storyline blender sub-module 313 may identify content of the thumbnail 2 to provide the necessary context for introducing the new character. Using the content and context of thumbnail 2 that provides the historical relevance for introducing the new character, the storyline blender 33 automatically generates an additional portion, wherein the additional portion includes the new character in the storyline narrative. The additional portion is generated to include an additional set of thumbnails that provides visual representation of the content with the new character and corresponding text content that describes the content in the additional portion. The additional portion is linked to the portion of the thumbnail 8 where the new character was used, so as to act as a storyline “flashback”. The flow of the storyline resulting from the generation of the additional portion is consistent and makes contextual sense.

In some implementations, the storyline prompts provided by the user may include sufficient details to generate a first portion 410A of the storyline. In such implementations, the storyline is developed iteratively one portion at a time. After the first portion is developed, the content of the first portion of the storyline is presented for user edits or for providing inputs to develop subsequent portion. FIG. 2 shows one such example, where the first portion of the storyline is developed using the initial storyline prompts provided by the user. The first portion of the storyline is shown to include first portion of thumbnails 410A and text content 420A that defines the corresponding content included in each thumbnail included in the first portion 410A.

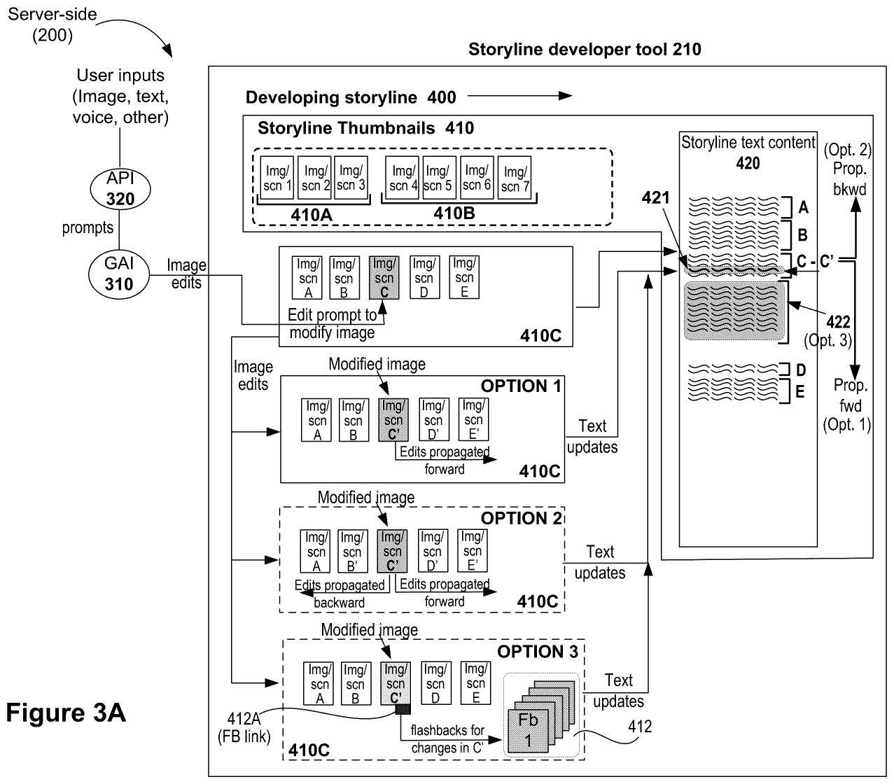

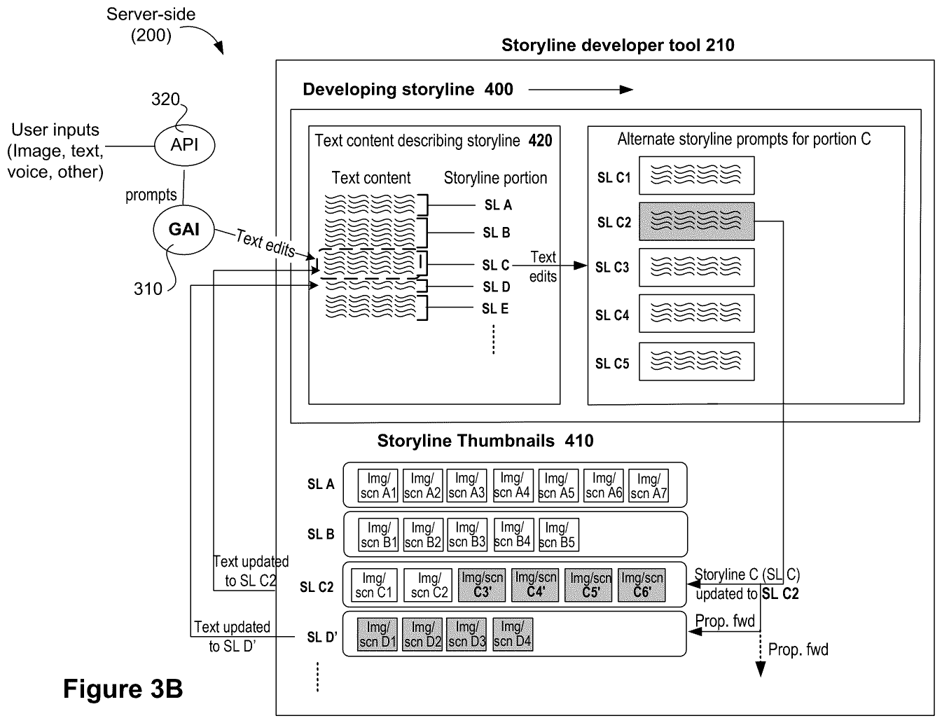

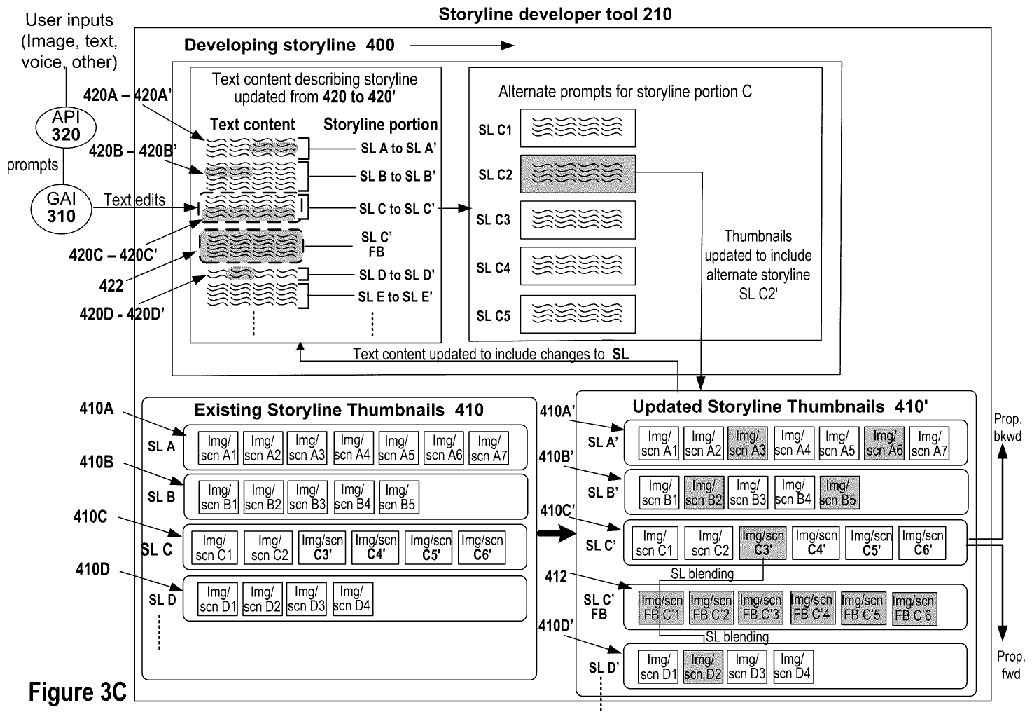

After generating the first portion, the GAI engine 310 forwards the first portion of the storyline to the client device 100 for rendering to obtain feedback from the user. In the example illustrated in FIG. 2, the first portion of the storyline is shown to include a set of 3 thumbnails 410A that includes images/scenes 1, 2, 3 and the corresponding text content 420A. The different components of the first portion of the storyline (i.e., thumbnails 410A and the corresponding text 420A) is presented on the user interface 100A with feedback options, wherein the feedback options (not shown) can be used to either edit the storyline included in the first portion or to provide additional prompts for developing the storyline further. The feedback options include one or more additional prompt options, and one or more edit options. The additional prompt options can include prompts corresponding to the different components that make up the content of the storyline, such as text options, image options, video options, audio options, etc. Each component related option can be used to provide details that the user would like to include in that component for developing the subsequent storyline. Similarly, each of the edit options can relate to a particular type of editing that can be performed to the storyline. For example, the edit options can include text edit option, image edit option, content edit option, video edit option, audio edit option, etc. More details of how each of the edit options are used to change a portion of the storyline will be discussed in depth with reference to FIGS. 3A-3C.

The additional options are used to develop a second/subsequent portion of the storyline. User selection of the appropriate additional component related option and inputs provided by the user at the user interface 100A are forwarded to the GAI engine 310, where it is interpreted and used to generate the second portion of the storyline, as shown in the example of FIG. 2, wherein the second portion includes a second set of 4 thumbnails 410B with content corresponding to images/scenes 4-7 and the text content 420B corresponding to each thumbnail in the second set 410B. In some implementations, the GAI engine 310 engages the consistency detector sub-module 312 to determine if the user inputs provided by selecting one or more of the additional prompts comply with the consistency rules 316 defined for the video game to ensure that the second portion of the storyline developed using the additional prompts has a consistent flow in the storyline narration. Upon successful verification that the additional prompts comply with the consistency rules 316, the second portion of the storyline is developed by the GAI engine 310 and added to the first portion as part of the developing storyline 400. The developing storyline 400 illustrated in FIG. 2 is shown to include storyline thumbnails 410 that include the thumbnails from the first and second portions (410A, 410B) and the text content includes the corresponding description (420A, 420B) of the content included in the first and second portions (410A, 410B). The process of receiving the additional prompts and developing the subsequent portions of the storyline continue so long as the user provides the inputs. As shown in FIG. 2, the inputs provided by the user using the storyline prompts are used to develop the third portion of the storyline, which includes the third set of thumbnails 410C encompassing images/scenes 8-10 and third set of text content (420C not shown) describing the content included in the third set of thumbnails 410C, and so on. Once the storyline is developed for the video game, the storyline is used to develop the video game. In some implementations, the storyline may be forwarded to a game engine to define the functional aspects of the video game.

When the user wants to edit one or more portions of the storyline developed with the user inputs, the user may use any one of the edit options provided on the user interface 100A and provide the necessary edits. User edits are used to update the corresponding portion of the storyline by first verifying that the user edits comply with the consistency rules 316 defined for the video game. The consistency rules 316 can be specifically defined for the user or for the video game (i.e., interactive application) based on the type of the video game (e.g., adventure, action, first person shooter, etc.) for which the storyline is being developed, context, purpose, content, level, etc., of the video game and preferences of the user, so as to ensure that the storyline, when developed, stays consistent and is in accordance to the user's preference.

FIGS. 3A-3C illustrate views of a developer tool interface for receiving and processing different types of inputs/edits provided by the user in refining a storyline developed for an interactive application, such as a video game, in accordance with some implementations. In the example view illustrated in FIG. 3A, the user edits can be in the form of image selection of a portion of content represented within a thumbnail (image/screen C) of the set of thumbnails 410C, as illustrated by the greyed box, wherein the set of thumbnails 410C define a third portion of the developing storyline 400. As illustrated, the developing storyline 400 already includes a first set of thumbnails representing the first portion 410A and corresponding text content 420A, a second set of thumbnails representing the second portion 410B and corresponding text context 420B, and a third set of thumbnails 410C representing the third portion and corresponding text content 420C, and so on. Thus, each portion of the storyline is defined to include a distinct set of thumbnails providing a visual representation of the storyline for the respective portions of content. User edits may be applied to modify a portion of the image/scene C within thumbnail C to generate the modified image/scene C′ and to re-generate the thumbnail C as thumbnail C′ with the modified image. The edits to the selected image/scene C within the set of thumbnails 410C cause a change to the corresponding text content 420C. For instance, a portion of the text content 420C corresponding to the portion of the updated image/scene C′ is updated to generate the updated text content 421. The edits to the image/scene C are also propagated forward as and when new thumbnails are generated for the storyline, as shown in Option 1. The propagation of the edits results in updating the images/scenes in the thumbnails following the selected thumbnail with the updated image scene C′, wherein thumbnail with image/scene D is re-generated by modifying image/scene D to generate the modified image/scene D′ and thumbnail with image/scene E is re-generated by modifying image/scene E to generate the modified image/scene E′.

Depending on the type of edits performed at the thumbnail to update image/scene C to re-generate the thumbnail with updated image/scene C′, the edits can not only be propagated forward as shown in Option 1 but can also be propagated backward, as shown in Option 2, by identifying and updating one or more images included in prior thumbnails generated for the storyline, in alternate implementations. Option 2 of FIG. 3A illustrates one such example, wherein the updates to image/scene C to generate the modified image/scene C′ also results in updating images/scenes included in prior thumbnails-re-generate the thumbnail by updating image/scene A to modified image/scene A′ and re-generate the thumbnail by updating image/scene B to modified image/scene B′. In the implementation illustrated in FIG. 3A, it is shown that all the thumbnails prior (thumbnails A, B) and subsequent thumbnails (thumbnails D, E) to the selected thumbnail (thumbnail C) with the updated image/scene C have been updated, as a mere example. It is not necessary to update all the thumbnails prior to and following the selected thumbnail (thumbnail with image/scene C). Rather only those thumbnails that occur prior to or following the selected thumbnail and include the updated images/scenes need to updated.

In alternate implementations, the updates to the image/scene C can result in inconsistency to the storyline due to mismatch of facts narrated or disclosed in different portions of the storyline. Thus, to address the inconsistency and to provide a consistent flow to the storyline, an additional portion of the storyline maybe generated to fill the gap causing the mismatch of facts in the storyline. For instance, the gap in the storyline may be due to some edits performed in a portion of the storyline. Detecting the gap, the GAI engine 310 generates an additional portion of the storyline to fill the gap, shown as Option 3 in FIG. 3A. The additional portion can include a set of thumbnails that provide a visual representation of a portion of the storyline used to fill the gap, and to use the additional portion as a ‘flashback’ portion. As noted previously, the flashback portion includes a prior portion of content of the storyline that is found to be historically relevant to the updates to the storyline resulting from the edits and building the additional portion to fill the factual gap. The additional portion is generated by the GAI engine 310 using the trained data so as to be contextually relevant to the storyline and includes a set of flashback thumbnails (412) and additional text content (422) that defines the content included in each flashback thumbnail in the set. The flashback thumbnails 412 are linked to the particular portion of the thumbnail with the updated image/scene C′ and stored so as to be used when generating the video game.

FIG. 3B illustrates a view of the developer tool interface that is used to provide edits to the storyline, in some alternate implementations. As shown in FIG. 3B, the user inputs are provided as text inputs, wherein a portion of the text content associated with the storyline is selected for editing. For example, the text content corresponding to the portion of the storyline ‘SL C’ is selected for editing. The edits to the text content maybe to change the storyline. Thus, upon detecting the selection of the text content pertaining to the portion (SL C) of the storyline, the GAI engine 310 generates alternate storyline prompts for the storyline and presents these alternate storyline prompts for user selection. In the example illustrated in FIG. 3B, alternate storyline prompts ‘SL C1’, ‘SL C2’, ‘SL C3’, ‘SL C4’ and ‘SL C5’ have been identified and presented in response to the user selecting to edit the portion of the storyline SL C. Each alternate storyline prompt is generated to correspond with a distinct variation in the path followed in the storyline. Selection of the alternate storyline path ‘SL C2’ is detected by the GAI engine 310 and, in response, the thumbnails corresponding to the portion of the storyline represented as ‘SL C’ is updated to generate updated thumbnails ‘SL C2’ that visually represents the storyline variation corresponding to SL C2. In addition to updating the portion of the thumbnails, the portion of the text content defining the content of thumbnails included in the portion SL C is updated to define the content of thumbnails included in the portion SL C2. Additional updates to the subsequent portion of the storyline can be done to keep the storyline consistent. FIG. 3B illustrates one such example, wherein in addition to updating the thumbnails from SL C to SL C2 and the text content to reflect the changes included in SL C2, the thumbnails of SL D is updated to thumbnails SL D′ and the text content updated from defining SL D to defining SL D′ by propagating the changes from SL C2 forward.

FIG. 3C illustrates an alternate view of the developer tool interface used to provide edits to adjust the storyline, in some alternate implementations. As with the example illustrated in FIG. 3B, the edits can be provided by selecting a portion of the text content (e.g., text content corresponding to storyline SL C shown in FIG. 3C). As with the example in FIG. 3B, responsive to detecting the selection of the text content of storyline C, a plurality of alternate storyline prompts are identified for the context included in the selected text content and presented for user selection. FIG. 3C shows 5 alternate prompts (SL C1, SL C2, SL C3, SL C4 and SL C5) identified for the selected text content and presented for user selection. As noted, each alternate storyline prompt defines a distinct variation in the path followed in the storyline. User selection of an alternate storyline prompt SL C2 is detected and used to update the corresponding content of one or more thumbnails generated for the storyline. FIG. 3C shows the existing thumbnails 410 defined for each portion of the storyline 400 developed using the inputs from the user along with the text content 420 describing the corresponding portion of content of the storyline contained in each thumbnail 410. For example, the initial storyline thumbnails 410 include a first set of thumbnails 410A (image/scene A1-image/scene A7) that is generated to visually represent the content in the first portion SL A of the developing storyline 400, a second set of thumbnails 410B (image/scene B1-image/scene B5) to visually represent the content in the second portion SL B of the storyline, and so on. The text content 420 providing a descriptive narrative of the storyline includes the first portion of text content 420A corresponding to the first set of thumbnails 410A, second portion of text content 420B corresponding to the second set of thumbnails 420B, and so on.

User selection of the alternate storyline prompt SL C2, results in updating the storyline. Updating of the storyline includes updating the thumbnails from the existing storyline thumbnails 410 to the updated storyline thumbnails 410′. The updating of the storyline results in updating thumbnail image/scene C3 of the portion of storyline SL C 410C to generate the updated thumbnail image/scene C3′ and the re-generation of the portion of the storyline SL C′ 410C′, which includes the updated thumbnail C3′. Additionally, the updates to the text content SL C2 can introduce some inconsistencies in the narration of the storyline. When such inconsistencies are introduced, they are addressed by generating additional portion of the storyline (represented by the set of thumbnails SL C′ FB 412 and the corresponding text content 422) to provide historical relevance to the concept introduced in the updated text content (i.e., storyline prompt SL C2) and blending the content of the additional portion (SL C′ FB 412 and text content 422) into the storyline (i.e., storyline blending) so that the storyline flows consistently and provides contextual relevance to the newly introduced concept. The edits that result in the generation of the additional portion (412, 422) can also cause updates to one or more other portions of the storyline in the forward and/or backward directions, wherein the updates to the other portions of the storyline include updates to the relevant thumbnails and the text content. These updates are used to re-generate the storyline. FIG. 3C shows the updates that were performed to the different portions of the storyline, wherein the updates were to sets of thumbnails (410A-410D) corresponding to different portions of the storyline (portions of storyline represented by SL A through SL D) and text content (420A-420D) to generate the updated corresponding sets of thumbnails (410A′-410D′) and the updated text content (420A′-420D′) for the updated portions of the storyline (portions of storyline represented by SL A′-SL D′). The process of receiving edits and updating portions of the storyline continue so long as the user provides the inputs for updating the storyline. In some implementations where the storyline is being developed iteratively by developing one portion at a time, depending on the inputs from the user for developing subsequent portions of the storyline, there can be additional portions of the storyline that may be generated to let the storyline flow without inconsistencies.

To summarize, the storyline developer tool 210 allows the user to develop their own storyline that can be used to generate a video game, for example. As the storyline is being developed, an user interface is provided to allow the user to do the edits. The user interface (i.e., developer tool interface for providing content to populate on the user interface of the client device) is configured to provide the logic to do the edits visually to an image within a thumbnail providing visual representation of content of the storyline or text-wise in the text representation that accompanies the thumbnails. The edits are provided to emphasize on certain content, de-emphasize certain other content, add or modify certain content, remove certain other content, vary the storyline path followed, shorten a particular portion of the storyline, lengthen a particular portion of the storyline, adjust a feature of a character or a rendering attribute of a scene, etc. The edits are provided to the GAI engine 310 to regenerate the storyline by adjusting the appropriate content, wherein the adjustments pivot around the specific concept or specific aspect of the concept (e.g., specific attribute of an image) that is being updated/changed by the edits so as to define a compelling storyline. An API may be used to interact with the GAI engine 310, which can be a separate external module or a separate internal module that is part of the logic that is providing the developer tool interface. Any inconsistencies from the edits are recognized and identified by the GAI engine 310 and proactively fix the inconsistencies by propagating the changes across the storyline or generate additional portion to make sense of the edits or suggest one or more alternate paths for the storyline to follow. The additional portion of the storyline is developed to give some context to the edits and is developed when prior portions of the storyline is to be left unchanged, in some implementations.

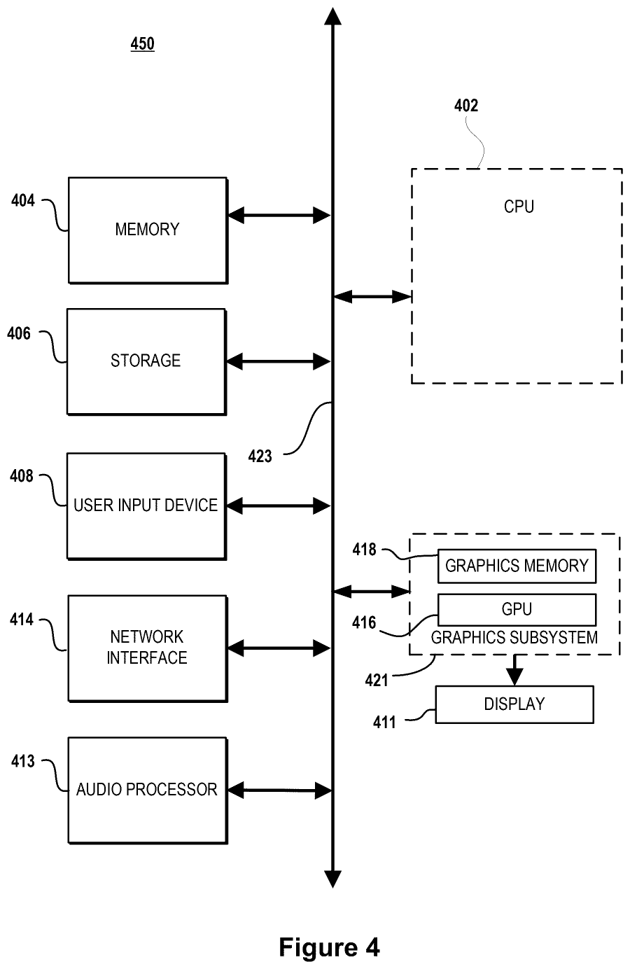

FIG. 4 illustrates components of an example device 450 (e.g., server device 200 of FIG. 1) that can be used to perform aspects of the various embodiments of the present disclosure. This block diagram illustrates a device 450 that can incorporate or can be a personal computer, video game console, personal digital assistant, a server or other digital device, suitable for practicing an embodiment of the disclosure. Device 450 includes a central processing unit (CPU) 402 for running software applications and optionally an operating system. CPU 402 may be comprised of one or more homogeneous or heterogeneous processing cores. For example, CPU 402 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 450 may be a localized to a player playing a game segment (e.g., game console), or remote from the player (e.g., back-end server processor), or one of many servers using virtualization in a game cloud system for remote streaming of gameplay to clients.

Memory 404 stores applications and data for use by the CPU 402. Storage 406 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 408 communicate user inputs from one or more users to device 450, examples of which may include keyboards, mice, joysticks, touch pads, touch screens, still or video recorders/cameras, tracking devices for recognizing gestures, and/or microphones. Network interface 414 allows device 450 to communicate with other computer systems via an electronic communications network, and may include wired or wireless communication over local area networks and wide area networks such as the internet. An audio processor 413 is adapted to generate analog or digital audio output from instructions and/or data provided by the CPU 402, memory 404, and/or storage 406. The components of device 450, including CPU 402, memory 404, data storage 406, user input devices 408, network interface 414, and audio processor 413 are connected via one or more data buses 423.

A graphics subsystem 421 is further connected with data bus 423 and the components of the device 450. The graphics subsystem 421 includes a graphics processing unit (GPU) 416 and graphics memory 418. Graphics memory 418 includes a display memory (e.g., a frame buffer) used for storing pixel data for each pixel of an output image. Graphics memory 418 can be integrated in the same device as GPU 416, connected as a separate device with GPU 416, and/or implemented within memory 404. Pixel data can be provided to graphics memory 418 directly from the CPU 402. Alternatively, CPU 402 provides the GPU 416 with data and/or instructions defining the desired output images, from which the GPU 416 generates the pixel data of one or more output images. The data and/or instructions defining the desired output images can be stored in memory 404 and/or graphics memory 418. In an embodiment, the GPU 416 includes 3D rendering capabilities for generating pixel data for output images from instructions and data defining the geometry, lighting, shading, texturing, motion, and/or camera parameters for a scene. The GPU 416 can further include one or more programmable execution units capable of executing shader programs.

The graphics subsystem 421 periodically outputs pixel data for an image from graphics memory 418 to be displayed on display device 411. Display device 411 can be any device capable of displaying visual information in response to a signal from the device 450, including CRT, LCD, plasma, and OLED displays. Device 450 can provide the display device 411 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction. During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A method for generating a storyline, comprising:
receiving inputs from a user for developing the storyline, the inputs include prompts usable in defining the storyline;
generating a first portion of the storyline using the prompts, wherein the first portion of the storyline includes a first set of thumbnails providing visual representation of the storyline and text content providing a description of content included in each of the first set of thumbnails, the first set of thumbnails and corresponding text content presented on a user interface for user interaction;
detecting selection of a specific portion of the storyline for editing from the user, the detection causing automatic generation of a plurality of additional prompts for editing one or more attributes of the specific portion, the plurality of additional prompts presented on the user interface for user selection; and
receiving the user selection of an additional prompt from the plurality of additional prompts rendered at the user interface, the additional prompt selected by the user used to edit a current version of the specific portion of the storyline, the editing resulting in refining the storyline to generate a modified storyline that conforms with changes defined in the additional prompt,
wherein the modified storyline is used to develop an interactive application.

2. The method of claim 1, wherein the specific portion of the storyline selected for editing is text content corresponding to a specific thumbnail of the first set of thumbnails, the editing of the text content used to refine the storyline.

3. The method of claim 2, wherein the plurality of additional prompts generated for editing the text content is based on context associated with the text content corresponding to the specific thumbnail of the first set of thumbnails, the plurality of additional prompts providing variations for the storyline.

4. The method of claim 2, wherein refining the storyline includes automatically re-generating the specific thumbnail with at least a portion of content included in the specific thumbnail updated to match editing done to the text content corresponding to the specific thumbnail.

5. The method of claim 1, wherein the specific portion of the storyline selected for editing corresponds to an image within a portion of content presented in a specific thumbnail within the first set of thumbnails.

6. The method of claim 5, wherein the plurality of additional prompts generated for editing corresponds with the portion of content of the specific thumbnail.

7. The method of claim 5, wherein refining the storyline includes automatically updating the text content associated with the specific thumbnail to correspond with the changes in the portion of the content presented in the specific thumbnail.

8. The method of claim 1, wherein the plurality of additional prompts generated for the specific portion of the storyline correspond to type of content selected for editing.

9. The method of claim 1, wherein refining the storyline includes propagating the changes in a forward direction during generation of a second portion of the storyline, the second portion of the storyline generated to include the changes provided in the additional prompt selected for editing the specific portion of the storyline in addition to the prompts of the inputs of the user.

10. The method of claim 1, wherein refining the storyline includes propagating the changes in a backward direction, wherein the propagating of the changes includes re-generating the storyline by updating at least one earlier portion of the storyline so as to provide relevancy and consistency to the changes applied to the specific portion of the storyline, the at least one earlier portion identified to be contextually relevant to the changes.

11. The method of claim 1, wherein refining the storyline includes generating a set of additional content for the storyline, the set of additional content providing historical relevance for the changes defined in the additional prompt selected for the specific portion of the storyline,
wherein the set of additional content includes a second set of thumbnails and the text content associated with each thumbnail included in the second set of thumbnails, the set of additional content generated to bridge a gap in the storyline resulting from the changes applied to the specific portion of the storyline, the set of additional content associated with the specific portion of the content so as to provide consistency to the storyline leading up to the specific portion of the content with the changes from the additional prompt.

12. The method of claim 1, wherein the inputs from the user for developing the storyline are received as voice prompts via a voice user interface activated in response to the user accessing an interactive interface used for developing the storyline.

13. The method of claim 1, further includes, responsive to detecting selection of the specific portion of the storyline for editing from the user, activating a voice user interface for receiving audio inputs specifying the changes for the specific portion of the storyline, the audio inputs interpreted and used to update the specific portion of the storyline.

14. The method of claim 1, wherein the storyline is generated to define a customized video game or a customized book for the user.

15. The method of claim 1, wherein generating the modified storyline further includes,
detecting selection of an attribute of an image included within the content of a specific thumbnail for editing by the user;
presenting additional prompts for the attribute of the image at the user interface for user selection, each of the additional prompts providing a variation of the attribute; and
updating, in response to the user selection of an additional prompt presented at the user interface, the attribute of the image within the specific thumbnail using the variation of the attribute identified in the additional prompt; and
propagating the variation of the attribute of the image forward when generating subsequent portions of the storyline.

16. The method of claim 15, wherein generating the modified storyline further includes,
propagating the variation of the attribute of the image backward by identifying the image with the attribute in one or more thumbnails that appear chronologically earlier to the specific thumbnail, so as to provide consistency to the attribute of the image within the storyline.

17. A method for generating a storyline, comprising:
receiving inputs from a user for developing the storyline, the inputs include prompts usable in defining the storyline;
generating a first portion of the storyline using the prompts, wherein the first portion of the storyline includes content presented in a first set of thumbnails providing visual representation of content of the storyline and corresponding text content describing the content of the storyline included in each of the first set of thumbnails, the first set of thumbnails and the corresponding text content presented on a user interface for user interaction;
presenting a plurality of additional prompts on the user interface for user selection, wherein each additional prompt of the plurality of additional prompts providing a variation to the storyline presented in the first portion by following a distinct path; and
detecting selection of an additional prompt from the plurality of additional prompts, the additional prompt defining the distinct path used in developing a second portion of the storyline following the first portion, the second portion of the storyline developed to include a second set of thumbnails providing the visual representation of the distinct path followed in the storyline and text content describing the corresponding content included in each of the second set of thumbnails,
wherein presenting the plurality of additional prompts and detecting selection of the additional prompt continues so long as the user continues to provide inputs to develop a subsequent portion of the storyline,
wherein the storyline is used to develop an interactive application.

18. The method of claim 17, wherein each additional prompt of the plurality of additional prompts is identified to provide a consistent flow to the storyline.

19. The method of claim 17, further includes,
detecting selection of a specific portion of the storyline for editing from the user;
providing one or more edit prompts for editing the specific portion, wherein each edit prompt of the one or more edit prompts identifying changes to one or more attributes of the specific portion of the storyline; and
receiving user selection of an edit prompt from the one or more edit prompts, the user selection causing application of the changes to the one or more attributes of the specific portion of the storyline to generate an adjusted storyline.

20. The method of claim 19, wherein the changes applied to the one or more attributes of the specific portion propagated in a forward direction, or in a backward direction, or in both forward and backward directions, so as to provide consistency in flow of the storyline including the changes,
wherein the changes are propagated in the forward direction, such that the changes to the one or more attributes of the specific portion of the storyline are taken into consideration when generating the subsequent portion of the storyline, and
wherein the changes are propagated in a backward direction by adjusting the one or more attributes to one or more portions of the storyline that appear prior to the specific portion, the adjusting causing re-generation of the adjusted storyline so as to provide consistent flow of the storyline with the changes incorporated.
